(19) United States
(12) Patent Application Publication
(10) Pub. No.: US 2012/0196986 A1
(43) Pub. Date: Aug. 2, 2012

(54) STABILIZED HUMIDITY-CURABLE POLYMERS HAVING 2-PHASE CURING KINETICS

(75) Inventors: Juergen Oliver Daiss, Muenchen (DE); Juergen Stohrer, Pullach (DE)

(73) Assignee: WACKER CHEMIE AG, Muenchen (DE)

(21) Appl. No.: 13/499,841

(22) PCT Filed: Oct. 8, 2010
(86) PCT No.: PCT/EP2010/065082

§ 371 Date: Apr. 2, 2012

(30) Foreign Application Priority Data
Oct. 20, 2009 (DE) 102009045866.2

(51) Int. Cl. C08L 51/00; C07F 7/18; C08F 8/00

(52) U.S. Cl. 525/333.7; 556/438

(57) ABSTRACT

The invention relates to stabilized mixtures (M) comprising a polymer (P) that can be humidity-cured into a cured polymer (PV), wherein the polymer (P) comprises hydrolysable silane groups at least one location not corresponding to the two ends of the main polymer chain, and silane (W) having at least one hydrolysable group as a water catcher, reacting faster with water at 25° C. and 1 bar than the humidity-curing polymer (P), and to a method for curing polymers (P) in mixtures (M) by means of water and particular silanes (W).

The present invention relates to stabilized mixtures comprising moisture-crosslinkable polymers with hydrolyzable silane groups and a water scavenger, and to a process for crosslinking the mixtures comprising water and water scavenger.

Moisture-crosslinkable polymers which are stabilized with water scavengers are known in the literature. The addition of water scavengers enables the processing of the moisture-crosslinkable polymers under atmospheric air too, which comprises water unless it is predried. Water scavengers react with penetrating water without causing crosslinking. A basic problem with these systems is that the kinetics of the moisture crosslinking of the stabilized system are slowed not only during processing but also thereafter, i.e. when the moisture-crosslinkable polymer is to be crosslinked in a controlled manner.

For example, EP 245 938, EP 7 765, and U.S. Pat. No. 4,043,953 describe polymers which are moisture-crosslinkable via silane functions, and which are stabilized by means of use of hydrolyzable silanes as water scavengers; EP 7 765 additionally mentions trialkyl orthoformates as water scavengers. EP 351 142 describes moisture-crosslinkable polymers which are stabilized with dipentaerythrityl esters. EP 149 903 describes the use of phosphorus compounds and antimony compounds as water scavengers. Documents EP 1 414 909 and EP 1 529 813 describe organic polymers with silane end groups, to which compounds with hydrolyzable groups, usually silanes, having a higher reactivity toward water than the silane-terminated polymers, have been added. In the case of silane-terminated polymers, such water scavengers are added with the purpose of improving the curing characteristics and the viscosity of the silane-terminated polymers, which is accomplished by chain extension, i.e. cocondensation of the water scavenger with the silane-terminated polymers. It should therefore be expected that the addition of a water scavenger can also be considered as the addition of a crosslinking agent which enhances the crosslinking of the overall system.

On the basis of U.S. Pat. No. 4,043,953, those skilled in the art should expect that compounds which condense rapidly with water act more as crosslinkers than as stabilizers and therefore, when they are added to moisture-crosslinking polymers, should quite simply accelerate the crosslinking. For silane-terminated polymers see documents EP 1 414 909 and EP 1 529 813, which specifically describe the assessment of those skilled in the art regarding the chain extension of silane-terminated polymers by added water scavengers.

The invention provides stabilized mixtures (M) comprising polymer (P) moisture-crosslinkable to give a crosslinked polymer (PV), said polymer (P) containing hydrolyzable silane groups at least one site which is not at either end of the polymer backbone, and silane (W) reacting with at least one hydrolyzable group as a water scavenger which reacts faster with water at 25° C. and 1 bar or at 90° C. and 1 bar than the moisture-crosslinkable polymer (P).

Silanes (W) which react faster with water at 90° C. and 1 bar than moisture-crosslinkable polymers (P) generally also react faster with water than the polymers (P) under other conditions, in particular within the temperature range from 0° C. to 300° C. and within the pressure range from 0 bar to 5000 bar, especially at 25° C. and 1 bar.

It has been found that mixtures (M) comprising moisture-crosslinkable polymers (P) have two-phase crosslinking kinetics when they are stabilized with at least one water scavenger (W) which reacts faster with penetrating water than the polymer (P), and the polymer (P) has at least one hydrolyzable silane group at least one site which is not at either end of the polymer backbone. The polymer backbone in the case of branched polymers is the longest possible repeat unit.

The adjustment of the hydrolysis kinetics of (P) versus that of the hydrolysis kinetics of (W), and the condensation kinetics of (P), allow crosslinking of the mixtures (M) by two-phase crosslinking kinetics, the first phase of the crosslinking kinetics being slower compared to the crosslinking of the same system without water scavenger (W), and the second phase of the crosslinking kinetics being faster compared to the crosslinking of the same system without water scavenger.

The advantage of such a system (M) is that, on commencement of action of moisture, crosslinking is greatly attenuated or absent, which enables, for example, the processing of the moisture-crosslinkable polymer (P) stabilized with water scavenger (W) under atmospheric moist air, and that crosslinking nevertheless takes place at an unattenuated rate after the processing—i.e. when crosslinking is actually desired. One measure of crosslinking is preferably the gel content, which increases during the crosslinking of the polymer (P).

Preferably, the polymer (P) has at least one structural element of the general formula I

Pol[−(R²)ₚ—SiR¹₃₋ₐXₐ]_{b} (I)

at least one site on the polymer which is not at either end of the polymer backbone, where
Pol- is a polymeric radical with a number-average molar mass Mₙ of at least 500 g/mol,
R¹ is an unsubstituted or mono- or poly-Q-substituted C₁-C₁₈ alkyl or C₆-C₁₀ aryl or Si₁—Si₂₀ siloxy radical or fused silane hydrolysate of silanes having 1, 2, 3 or 4 hydrolyzable groups,
R² is a divalent unsubstituted or mono- or poly-Q-substituted hydrocarbyl radical having 1-20 carbon atoms, which may be interrupted by one to three heteroatoms, or a siloxane radical having 1-20 silicon atoms, in which the silicon atoms may likewise bear R¹ or X groups,
Q is a fluorine, chlorine, bromine, iodine, cyanato, isocyanato, cyano, nitro, nitrato, nitrito, silyl, silylalkyl, silylaryl, siloxy, siloxanoxy, siloxyalkyl, siloxanoxyalkyl, siloxyaryl, siloxanoxyaryl, oxo, hydroxyl, epoxy, alkoxy, aryloxy, acyloxy, S-sulfonato, O-sulfonato, sulfato, S-sulfinato, O-sulfinato, amino, alkylamino, arylamino, dialkylamino, diarylamino, arylalkylamino, acylamino, imido, sulfonamido, imino, mercapto, alkylthio or arylthio substituent, O-alkyl-N-carbamato, O-aryl-N-carbamato, N-alkyl-O-carbamato, N-aryl-O-carbamato, optionally alkyl- or aryl-substituted P-phosphonato, optionally alkyl- or aryl-substituted O-phosphonato, optionally alkyl- or aryl-substituted P-phosphinato, optionally alkyl- or aryl-substituted O-phosphinato, optionally alkyl- or aryl-substituted phosphino, hydroxy-carbonyl, alkoxycarbonyl, aryloxycarbonyl, cyclic or acyclic carbonate, alkylcarbonato or aryl-carbonato substituent,
p may assume the values of 0 or 1,
a may assume the values of 1, 2 or 3,
b may assume integer values greater than or equal to 1 and
x is a hydrolyzable group,
   and where two or more radicals or groups within the formula I may be joined to one another so as to form one or more rings.

The polymer (P) may have certain degrees of crystallinity, determined by X-ray diffraction or by enthalpy of fusion, which are selected advantageously according to the application. The same applies to the viscosities, degrees of branching or molar masses of (P). The molar mass distributions of the polymers (P) may be unimodal, bimodal or multimodal. The silane groups can be introduced into polymer (P), for example, by grafting (for example by ionic or free-radical means), cocondensation, addition reaction, copolymerization (for example free-radical copolymerization of silanes having unsaturated organo-functional groups with olefinic monomers), by metathesis reaction (for example organometallic) or by Benkeser reaction, or by two or more of the reactions mentioned, which can be executed simultaneously or successively.

Pol- is the radical of a polymer (P1). Preferably, the polymer (P1) is a polyolefin, a linear, branched, highly branched or hyperbranched polyolefin, which has been prepared, for example, by polymerization of olefins under free-radical conditions or with metallocene, Phillips or Ziegler-Natta catalysts or with catalysts capable of a “chain walking isomerization”, or by ionic polymerization, for example polyethylene, a branched, highly branched or hyperbranched polyethylene, or a C₃-C₁₈ poly-α-olefin (e.g. polymers of propene, 1-butene, 2-methyl-1-propene) or a copolymer of the aforementioned poly-olefins (e.g. ethene-α-olefin copolymer, especially ethene-propene copolymer, ethene-1-butene copolymer, ethene-1-hexene copolymer and ethylene-1-octene copolymer, ethene-propene-1-butene terpolymer, LLDPE); rubbers; polyvinyl acetate, an ethene-vinyl acetate copolymer; an ethene-vinyl ether copolymer, for example ethene-ethyl vinyl ether, ethene-butyl vinyl ether or ethene-isobutyl vinyl ether copolymer; a polyolefin or poly-α-olefin homo- or copolymer wax; polyesters, for example poly-1,4-butylene glycol or -1,2-ethylene glycol or -diethylene glycol terephthalate or phthalate or adipate; polyamide (Nylon® or Perlon® type); an acrylate polymer or acrylate copolymer, for example ethylene-butyl acrylate copolymer, ethylene-ethyl acrylate copolymer, ethylene-methyl acrylate copolymer, ethylene-acrylic acid copolymer, where the latter may also be present partly or fully in the form of a salt, for example of a zinc salt, poly(methyl acrylate), poly(ethyl acrylate), poly(butyl acrylate); a meth-acrylate polymer or methacrylate copolymer, for example ethylene-butyl methacrylate copolymer, ethylene-ethyl methacrylate copolymer, ethylene-methyl methacrylate copolymer, ethylene-methacrylic acid copolymer, where the latter may also be present partly or fully in the form of a salt, for example of a zinc salt, poly(methyl methacrylate), poly(ethyl methacrylate), poly(butyl methacrylate); a polyalkylene oxide such as poly-ethylene oxide or polypropylene oxide, or a polyether, for example of tetrahydrofuran, or a copolymer or a block copolymer or a graft copolymer formed from two or more of the polymers mentioned.

R¹ is preferably an unsubstituted C₁-C₆ alkyl or phenyl radical, especially methyl or ethyl radical.

R² is preferably an unsubstituted organic radical which has 1 to 10 carbon atoms and may be interrupted by 0 or N when it has at least 3 carbon atoms. Preference is given to no interruption with O or N, or interruption with one or two heteroatoms selected from O and N.

Preferred R² include alkyl radicals having 1, 2, 3, 4 or 5 carbon atoms. Preferred substituents Q on R² include oxo. The preferred number of substituents Q on R² is 0, 1 or 2.

Preferred X radicals are alkoxy, alkenyloxy, amino, hydrocarbylamino, acylamino, propenyl-2-oxy, amino, C₁-C₁₀-alkylamino, C₆-C₂₀-arylamino, C₁-C₁₀-dialkylamino, C₆-C₂₀-diarylamino and C₆-C₂₀-aryl-C₁-C₁₀-alkylamino, especially C₁-C₆ alkoxy, such as methoxy, ethoxy, n-propoxy, isopropoxy, n-butoxy, isobutoxy, sec-butoxy, tert-butoxy, n-pentoxy, isopentoxy, sec-pentoxy, tert-pentoxy. Preferably, X radicals are bonded to silicon via oxygen atoms.

a preferably has the values of 2 or 3.

b preferably represents the integers selected from 1 to 100, preferably integers selected from 1 to 20, especially from 1 to 5. Examples of b are 1, 2, 3, 4, 5, 6 and greater.

Based on an arbitrary sample of the polymer (P), the ratio of n(Σb):n(P), i.e. the ratio of the sum of all b, summed over all molecules of the polymer (P) in the sample, to the number of molecules of the polymer (P) in the sample, is preferably at least 0.01, especially preferably at least 0.1, and preferably at most 20, especially at most 50. The ratio n(Σb):n(P) can be determined by, for example, determining the molar concentration c(Σb) of structural elements of the general formula I per gram of polymer (P) (unit [mol/g]). This determination can be determined, for example, by nuclear magnetic resonance, by atomic absorption spectroscopy (“AAS”; element to be quantified: Si), by analysis in an inductively coupled plasma (“ICP”; element to be quantified: Si), by infrared spectroscopy (band to be integrated, for example, Si—OMe), by measuring the number of releasable HX groups by hydrolysis or by asking (calculation of the molar amount of Si as SiO₂ in the ash). In that case:

n(Σb):n(P)=c(Σb)×Mₙ(P)

where Mₙ(P) is the number-average molar mass of the polymer (P). Mₙ is determinable, for example, by gel permeation chromatography.

The polymer (P), based on the total mass of (P), contains preferably at least 0.01%, more preferably at least 0.1%, especially at least 0.2%, and preferably at most 50%, more preferably at most 30%, especially at most 20%, of silane groups, based on the mass of all —[(R²)ₚ—SiR¹₃₋ₐXₐ]_{b} groups in relation to the total mass of polymer (P).

The water scavenger (W) is preferably a silane of the general formula II

(R³)_{4-c-q}(Y)_{c}Si(CH₂—Z)_{q} (II)

where
R³ may assume the same definitions as R¹ or as X,
q may assume the values of 0, 1, 2 or 3,
c may assume the values of 1, 2, 3 or 4,
Y is a hydrolyzable group,
Z is a heteroatom-containing group bonded to the CH₂ group via a heteroatom,
q+c may assume the values of 1, 2, 3 or 4,
   and where two or more radicals or groups within the general formula II may be joined to one another so as to form one or more rings.

Faster reaction of the water scavenger (W) with water than the polymer (P) is preferably achieved by (A) selecting X and Y in the general formulae (I) and (II) such that the selected pKₐ of the Brønsted acid YH conjugated to give Y⁻ is lower than the pKₐ of the Brønsted acid XH conjugated to give X⁻, where Y⁻ is a leaving group on a silicon atom of structural elements of the general formula II and X⁻ is the leaving group on the silicon atom of structural elements of the general formula I; when X or Y is an Si-bonded amino function, the pKₐ of the next-but-one conjugated acid to give X⁻ or Y⁻, i.e. the pKₐ of XH₂⁺ or of YH₂⁺, is employed for the comparison of the pKₐ values, i.e. the pKₐ of XH is, when neither X nor Y is an amino radical, compared with the pKₐ of YH; the pKₐ of XH is, when Y is an amino radical and X is not an amino radical, compared with the pKₐ of YH₂⁺; the pKₐ of XH₂⁺ is, when Y is not an amino radical and X is an amino radical, compared with the pKₐ of YH; and the pKₐ of XH₂⁺ is, when Y is an amino radical and X is an amino radical, compared with the pKₐ of YH₂⁺, or

(B) selecting q in the general formula II to be 1, 2 or 3, or
(C) selecting X and Y such that XH and YH are alcohols, XH being a hindered alcohol with greater steric demands in the environment of the alcoholic hydroxyl group than YH, the steric demand of the substituent on the alcoholic hydroxyl function being in ascending order in the series of methyl<ethyl<n-propyl<n-butyl<C₅-C₂₀ n-alkyl<isobutyl<isopropyl<sec-butyl<C₅-C₂₀ sec-alkyl<tert-butyl<tert-pentyl≈C₆-C₂₀ tert-alkyl, or
(D) the value selected for c in the general formula II being greater than the value of a in the general formula I, or one of the prerequisites (A), (B), (C) or (D) being met, or the prerequisites (A) and (B) or (A) and (C) or (A) and (D) or (B) and (C) or (B) and (D) or (C) and (D) or (A), (B) and (C) or (A), (B) and (D) or (A), (C) and (D) or (B), (C) and (D) or (A), (B), (C) and (D) being met at the same time.

Preferably, prerequisite (B) is met. q in this case preferably assumes the value of 1.

Particularly suitable water scavengers (W) having at least one structural unit of the general formula II are the silanes of the general formula III

R⁴—CH₂—C(═O)—O—CH₂—Si(R⁵)_{3-c}(Y¹)_{c} (III)

where
R⁴ is a saturated or mono- or polyunsaturated, unsubstituted, acyclic, monocyclic or bicyclic C₃-C₄₀ alkyl radical or C₇-C₄₀ aryl radical or C₇-C₄₀ arylalkyl radical or C₇-C₄₀ alkylaryl radical which consists only of carbon and hydrogen atoms and
Y¹ is an optionally substituted C₁-C₂₀ alkoxy radical and
R⁵ is an unsubstituted C₁-C₄₀ hydrocarbyl radical and
c may assume the same definitions as defined above.

The silanes of the general formula III likewise form part of the subject matter of the invention.

R³ is preferably an unsubstituted C₁-C₆ alkyl or phenyl radical, especially methyl or ethyl radical.

R⁴ is preferably an unsubstituted C₄-C₂₀ alkyl radical or a C₇-C₂₀ aryl radical or a C₇-C₂₀ alkylaryl radical or a C₇-C₂₀ arylalkyl radical, especially C₅-C₂₀ alkyl radical. R⁴ is preferably saturated. R⁴ is preferably acyclic. R⁴ is preferably linear.

R⁵ is preferably an unsubstituted C₁-C₆ alkyl or phenyl radical, especially methyl or ethyl radical.

Preferred Y radicals correspond to the preferred X radicals. Preferably, Y radicals are bonded to silicon via oxygen atoms.

Preferred Y¹ radicals are unbranched alkoxy radicals or (alkoxyalkoxy) radicals, especially methoxy, ethoxy or (2-methoxyethoxy) radicals.

Z is preferably a fluorine, chlorine, bromine or iodine substituent or a monovalent radical bonded via oxygen, sulfur, nitrogen or phosphorus. Preferably, Z means OR¹¹, OC(O)R¹², OC(O)OR¹¹, OC(O)NR¹³₂, N(R¹³)C(O)OR¹¹, N(R¹³)C(O)NR¹³₂, NR¹³₂, N(R¹³)[C(O)R¹²], N[C(O)R¹²]₂. N(R¹³)S(O)₂R¹⁴, N[C(O)R¹²] [S(O)₂R¹⁴], N[S(O)₂R¹⁴]₂, S(O)₂R¹⁴, OS(O)₂R¹⁴, S(O)R¹⁴, OS(O)R¹⁴, P(O) (OR¹⁵)₂, O—N═C(R¹²)₂, F, Cl, Br or I groups, more preferably OC(O)R¹², OC(O)NR¹³₂. N(R¹³)C(O)OR¹¹, N(R¹³)C(O)NR¹³₂, NR¹³₂, N(R¹³)[C(O)R¹²], N[C(O)R¹²]₂. N(R¹³)S(O)₂R¹⁴, N[C(O)R¹²] [S(O)₂R¹⁴], P(O)(OR¹⁵)₂ groups, where R¹¹, R¹⁴ and R¹⁵ are each optionally substituted C₁-C₂₀-alkyl or C₆-C₂₀-aryl radicals and R¹² and R¹³ are each hydrogen or optionally substituted C₁-C₂₀-alkyl or C₆-C₂₀-aryl radicals, and R¹¹, R¹², R¹³, R¹⁴ and R¹⁵ within one Z group may each be joined to one another so as to form rings.

If the embodiment designated (A) above is implemented, the pKₐ of part or all of YH or of YH₂⁺ is preferably at least 0.5 units and especially at least 1.0 unit less than that of XH or XH₂⁺, applying the above-described selection criteria for the decision as to whether the pKₐ of YH or YH₂⁺ is applied with the pKₐ of XH or XH₂⁺.

For the molar ratio of water scavenger (W) to polymer (P), it is sensible to employ the ratio of the sum of molar amounts of all hydrolyzable Y groups in (W), n(ΣY), to all hydrolyzable X groups in (P), n(ΣX). The molar ratio n(ΣX):n(ΣY) is preferably at least 1:100, especially at least 1:10, and at most 100:1, especially at most 10:1. This ratio and the concentrations present in absolute terms, namely n(ΣX)/m(M) and n(ΣY)/m(M), determine the characteristics of the two phases of the crosslinking kinetics. The greater the concentration n(ΣY)/m(M) and the smaller the ratio n(ΣX):n(ΣY), the longer the first phase of the crosslinking kinetics, the stabilization phase, takes under otherwise comparable conditions, and vice versa. Those skilled in the art can find out easily by exploratory tests how much water scavenger (W) need be present in the mixture (M) for other given mixture constituents, in order to achieve the desired extent and the desired duration of stabilization of the mixture (M) against moisture crosslinking under the given conditions. The mixture (M) contains preferably at least 0.01%, more preferably at least 0.1%, especially at least 0.2%, and preferably at most 50%, more preferably at most 30%, especially at most 20%, of water scavenger (W).

The mixtures (M) can be produced by admixing at least one polymer (P) with a water scavenger (W).

This process may also be repeated twice or three times in succession with polymer (P) with a water scavenger (W). The mixtures (M) can be produced, for example, in single-screw extruders or in twin-screw extruders, preferably co-rotating, or in dynamic or static mixers, or in stirred tanks or impact mixers or dwell tanks. Preferably, the blend is produced at temperatures above the melting point of the polymer (P), but the mixture can also be produced, for example, by diffusion of water scavenger (W) in solid polymer (P). The mixture (M) may likewise comprise heterogeneously mixed polymer (P) and water scavenger (W), such that mixing is accomplished in the course of user processing; for example, the mixture (M) may comprise one granular material comprising a polymer (P), and a second granular material comprising a water scavenger (W). Water scavengers (W) can also be added directly in the course of the operation to prepare polymers (P).

The mixtures (M) may be in portions. For instance, they can be dispensed as such or as a blend with further additives, for example as a melt, and optionally cooled, which gives rise to solidified melt blocks, for example, after cooling, or, for example, mechanically granulated from the solid state, ground, crushed, cut, rolled, pressed, extruded, crystallized or precipitated from the melt or from solution, pelletized, cooled in liquid or semi liquid form as droplets, optionally on a carrier material, to give pellets, or dissolved from the liquid or solid state by the action of a solvent, or knife-coated onto, for example, carrier films, and so examples of supply forms include bars, rods, sheets, films, pellets, flakes, granules, powders, blocks, solutions or melts, which can optionally be dispensed into ready-to-use vessels, for example cartridges, or packaged into containers such as vats, films, sacks or bags, which preferably provide protection from the ingress of atmospheric humidity. Examples of additives which may be added include catalysts, desiccants, antioxidants or antiblocking agents. Preference is given to effecting steps such as portioning, mechanical comminution, bringing into solution, shaping, dispensing, storage, shipping and use under an inert gas atmosphere, which preferably has a water content of less than 1000 ppm, especially less than 100 ppm. The inert atmosphere preferably comprises for the most part nitrogen or argon. “Inert” in this context means a low water content; at the same time, the inert atmosphere may comprise oxygen, preference being given to oxygen contents of less than 5% by volume, especially <1% by volume.

The invention also provides a process for crosslinking polymers (P) in mixtures (M) with water. Some or all of the crosslinking is preferably performed only in the course of or after processing of the mixture (M).

The moisture crosslinking of the polymer (P) in mixtures (M) comprising at least one polymer (P) gives rise to the crosslinked polymer (PV). As well as the formation of (PV), it is possible for further condensation products of (PV) to form and for intermediates to be passed through.

In the first phase of the overall kinetics, principally the water scavenger (W) reacts with penetrating water and forms, possibly with elimination of condensation by-products, the hydrolyzed water scavenger (WH), the moisture-crosslinked water scavenger (WV), or corresponding condensates with polymers (P), designated as [(P)(W)], [(P) (WH)] or [(P)(WV)], or a mixture of these compounds. “Principally” in the context of the present invention means that the mixture (M) stabilized with silane (W) and comprising polymer (P) forms a moisture-crosslinking product of (P), called (PV), more slowly than an otherwise identical system without water scavenger (W) would do so. During the first phase of the crosslinking kinetics, it is also possible for hydrolysis products (PH) of the polymer (P) to form, and these can also form condensation products with water scavenger (W) or with hydrolysis products (WH) of the water scavenger or with condensation products (WV) of the water scavenger, which are designated as [(PH)(W)], [(PH)(WH)] or [(PH)(WV)]. In the second phase of the kinetics of the moisture crosslinking, however, this reacts with water scavenger (W) (which may now be present as water scavenger (W) or in hydrolyzed form (WH) or in crosslinked form (WV) or as condensate [(P)(W)], [(P)(WH)], [(P)(WV)], [(PH)(W)], [(PH)(WH)] or [(PH)(WV)] or as a mixture of these) faster with water than an otherwise identical system to which no water scavenger (W) has been added at the outset would do so. In the second phase of the crosslinking kinetics, significant amounts of moisture-crosslinking polymers (PV) or condensation products thereof with water scavenger (W) or with hydrolysis products (WH) of the water scavenger (W) or with condensation products (WV) of the water scavenger (W) can be formed, which are designated [(PV)(W)], [(PV)(WH)] or [(PV)(WV)]. The water scavenger (W) may also comprise, from the start, partly or fully hydrolyzed components (WH) or partly or fully condensed components (WV), or, from the start, may comprise as condensates with polymer (P) or with partly or fully hydrolyzed polymer (PH), i.e. in that case is in the form of [(P)(W)], [(P)(WH)], [(P)(WV)], [(PH)(W)], [(PH)(WH)] or [(PH)(WV)]. It is likewise possible for the polymer (P) also to comprise, from the start, partly or fully hydrolyzed components (PH).

The 2-phase crosslinking kinetics described open up the possibility of processing a mixture (M) stabilized in this way during the first phase with ingress of moisture, for example under air under atmospheric conditions, without any disruption of the processing by the action of moisture. After the processing, which generally includes a shaping step, for example to give a pipe or cable insulation or to give a solid shaped body, or the production of an adhesion site or adhesive-bonded structure, very rapid crosslinking is desirable. This is exactly what enables the inventive stabilized mixtures (M). Conventional (noninventive) water scavengers attenuate the moisture crosslinking kinetics of the system over the entire period, i.e. during both phases. During the first phase this is entirely desirable—in general, the noninventive water scavengers do not attenuate the kinetics as effectively as the water scavengers (W) do so during the first phase of the crosslinking. However, the main disadvantage of the noninventive water scavengers is that the noninventive water scavengers also continue to attenuate the crosslinking kinetics of moisture-crosslinkable polymers (P) within the period of the second phase—i.e. when rapid crosslinking is actually desired—whereas the water scavengers (W) in this second phase act as crosslinkers, i.e. surprisingly only now display the effect that would be expected by a person skilled in the art from these compounds from the start, and hence suppress preliminary crosslinking during processing and thereafter enable fast crosslinking exactly when it is desired.

The water required for crosslinking can be used in the form of water vapor and/or liquid water, or be provided by air humidity. The crosslinking can be executed preferably at least 0° C., more preferably at least 5° C., especially at least 10° C., especially preferably at least 15° C., and preferably at most 300° C., more preferably at most 200° C., especially at most 170° C., especially preferably at most 140° C. The crosslinking can be executed at least 0 bar, more preferably at least 0.5 bar, especially at least 0.9 bar, and preferably at most 5000 bar, more preferably at most 20 bar, especially at most 10 bar, more preferably at atmospheric pressure. The crosslinking preferably commences in the course of or after the processing of the mixture (M). The process for crosslinking can be executed in the presence of one or more catalysts. The catalysts may bring about acceleration of the moisture crosslinking of the polymers (P) in the mixtures (M), by catalyzing the hydrolysis of the hydrolyzable silane groups present in the polymer (P) under the action of water and/or condensation thereof to give siloxanes. The catalysts may have the same effect on the water scavengers (W).

At least one mixture (M) with at least one polymer (P) is, for example, mixed with a catalyst or with a masterbatch of the catalyst, i.e. a mixture of the catalyst with a suitable polymer of the same or different type, preferably mixed in the melt, preferably in an extruder.

Preferably, the mixture (M) contains at least 0.1 and especially at least 0.2 part by mass, and preferably at most 5 and especially at most 20 parts by mass, of the catalyst per 100 parts by mass of polymer (P).

Preferably, the finished mixture (M) contains at least 0.0001%, preferably at least 0.001% and more preferably at least 0.01% by weight, and preferably at most 5%, more preferably at most 1% and especially preferably at most 0.2% by weight of catalyst.

Examples of useable catalysts include organotin compounds, such as dibutyltin dilaurate, dioctyltin dilaurate, dibutyltin oxide, dioctyltin oxide, tin salts, for example tin(II) isooctanoate, titanium compounds, for example titanium(IV) isopropoxide, aza compounds, such as 1,8-diazabicyclo[5.4.0]undec-7-ene, 1,5-diazabicyclo[4.3.0]non-5-ene, 1,4-diazabicyclo-[2.2.2]octane, bases, for example organic amines, such as triethylamine, tributylamine, ethylenediamine, or inorganic or organic acids, such as toluenesulfonic acid, dodecylbenzenesulfonic acid, stearic acid, palmitic acid or myristic acid. Particular preference is given to performing the crosslinking of the polymer (P) in the mixture (M) without added tin or compounds of tin. More particularly, the tin content based on the element (Sn) in mixtures (M) is Sn<30 ppm, more preferably Sn<5 ppm.

Whether any catalyst, and how much thereof, is required or beneficial in the use intended in each case can be determined easily by those skilled in the art by exploratory tests.

The mixtures (M) can be used as reactive melt-applied adhesives, for the production of coatings or adhesive bonds on a wide variety of different substrates, for the production of shaped bodies or for the production of elongated goods, for example cable insulation, sheathing or pipes.

The mixtures (M) can preferably be processed by the same methods as the methods with which analogous systems without the corresponding water scavenger (W) are processed, the inventive mixtures, due to their elevated stability against unwanted preliminary cross-linking, having advantages in the course of processing, and, due to their rapid crosslinking after processing, having process advantages in the crosslinking of the end product.

All above symbols in the above formulae are each defined independently of one another. Unless stated otherwise, the above percentages are percentages by weight and the above pressure figures are absolute pressures. In all formulae, the silicon atom is tetravalent. Unless stated otherwise, the reactions in the examples which follow, including the crosslinking reactions, were executed at atmospheric pressure (about 1 bar).

### EXAMPLES

### Silane Syntheses

### Preparation of a Water Scavenger (W)

### Example 1

### Synthesis of (caprylatomethyl)trimethoxy-silane

(MeO)₃SiCH₂Cl+NaOC(O)-n-C₇H₁₅->(MeO)₃SiCH₂OC(O)-n-C₇H₁₅+NaCl

To a solution of 14.78 g (43.6 mmol) of tetrabutyl-phosphonium bromide (from Fluka) in 372.1 g (2.18 mol) of (chloromethyl)trimethoxysilane (from Wacker Chemie AG) were added 181.1 g (1.09 mol) of sodium caprylate (from Fluka) [=n-C₇H₁₅—C(O)ONa], and the mixture was stirred at 130° C. for 2.5 hours. Then a further 181.1 g (1.09 mol) of sodium caprylate were added and the mixture was stirred at 130° C. for a further 3.5 hours. The mixture was cooled to room temperature and filtered, the filtercake was washed with 3×150 ml of xylene (isomer mixture), and filtrate and wash solutions were combined and distilled under reduced pressure. The product was obtained in 71% yield (431.3 g, 1.55 mmol) as a clear, colorless liquid, b.p. 115° C./2.5 mbar.

### Production of Polymers (P), Mixtures (M) and Crosslinking Characteristics

All parts reported hereinafter are parts by mass.

For the tests, the following silanes were used:
Silane A: Vinyltrimethoxysilane (GENIOSIL® XL 10, Wacker Chemie AG, Germany)
Silane B: (Caprylatomethyl)trimethoxysilane from Example 1
Silane C: Hexadecyltrimethoxysilane (Silan 25013 VP, Wacker Chemie AG, Germany)

### Example 2a-b

### Silane Grafting on Polymer in a Laboratory Extruder, Preparation of a Polymer (P) and Production of an Inventive Mixture (M)

The graft reaction was conducted in a co-rotatory twin-screw extruder (Berstorff ZE 25) at an L/D ratio of 47 and a screw diameter of 25 mm. The extruder was operated with the following parameters: temperature profile (in ° C.): 130/130/150/190/210/215/215/210/210 (head temperature); output approx. 10 kg/h; speed 200 rpm.

The medium-density polyethylene (MDPE) used is characterized by a melt index of 3.5 g/10 min (2.16 kg/190° C.), a density of 944 kg/m³ and a Vicat softening point of approx. 123° C.

For Example 2a, silane A, silane B and peroxide were blended in a mass ratio of 1.00:1.87:0.10; for Example 2b, silane A and peroxide were blended in a ratio of 1.00:0.10; the respective mixture was metered into the polymer melt in the third heating zone at 150° C. with the aid of a Viscotec metering pump.

The peroxide used for the tests was di-tert-butyl peroxide (DTBP, from Merck).

The silane grafts conducted are summarized in Table 1 below.

TABLE 1
Silane grafts conducted (parts by weight)

| Ex. No. | 2a | 2b** |
|---|---|---|
| MDPE | 100 | 100 |
| DTBP | 0.1 | 0.1 |
| Silane A | 1.00* | 1.00* |
| Silane B | 1.87* | |

*corresponds to 67.5 mol per kg of MDPE
**noninventive (comparative example)

The resulting graft polymers were pelletized and stored under nitrogen with exclusion of moisture.

The graft polymers contained the following structural units: Pol[-CH₂—CH₂—Si(OMe)₃]_{b} and Pol[-CH(Me)-Si(OMe)₃]_{b}, corresponding to the definition of a polymer (P), the unit Pol- in these structural units representing a radical of the medium-density polyethylene used, and where b was principally in the range of 1-4, especially around 2.

The product from Example 2a further contained (caprylatomethyl)trimethoxysilane with the structure n-C₇H₁₅—C(O)—O—CH₂—Si(OMe)₃, corresponding to the definition of a water scavenger (W).

The product produced from Example 2a thus corresponds to an inventive mixture (M) in embodiment (B).

### Example 3

### Production of a Catalyst Masterbatch

The production of a catalyst masterbatch was performed in a co-rotatory twin-screw extruder (Berstorff ZE 25) at an L/D ratio of 47 and a screw diameter of 25 mm. The extruder was operated with the following parameters: temperature profile (in ° C.): 130/130/150/190/210/215/215/210/210 (head temperature); output approx. 10 kg/h; speed 200 rpm.

The carrier material used was medium-density poly-ethylene (MDPE), which is characterized by a melt index of 3.5 g/10 min (2.16 kg/190° C.), a density of 944 kg/m³ and a Vicat softening point of approx. 123° C.

The polyethylene was blended with the catalyst beforehand. The mixture was metered into the intake region of the twin-screw extruder with the aid of a metering balance (from Brabender).

For the production of the catalyst masterbatches, the following catalysts were used:

Catalyst A: dioctyltin dilaurate (DOTL), Wacker Chemie AG, Germany

The following mixing ratio was established:

MDPE: 98.8 parts

Catalyst A: 1.2 parts

The resulting catalyst masterbatches were pelletized and stored under nitrogen with exclusion of moisture.

### Examples 4a-b

### Production of Test Specimens for the Crosslinking

The graft polymers prepared in Example 2a-b were blended with the catalyst masterbatch prepared in Example 3, as specified in Table 2 below.

TABLE 2
Composition of the test specimens for
the crosslinking (parts by weight)

| Ex. No. | 4a | 4b** |
|---|---|---|
| Graft polymer | | |
| from Example | | |
| 2a | 95 | |
| 2b** | | 95 |
| Catalyst | | |
| masterbatch | | |
| from Example | | |
| 3 | 5 | 5 |

**noninventive

### Example 5a-b

### Crosslinking Characteristics

The mixtures according to Example 4a-b were extruded to sample bars on a single-screw analytical extruder (from Göttfert) with an L/D ratio of 20 and a screw diameter of 30 mm through a die (diameter 5 mm).

The extruder was operated with the following parameters: temperature profile (in ° C.): 180/190/195/200 (head temperature); speed 25 rpm; fill level 100%.

The sample bars produced according to Example 4a-b were cut into samples of length approx. 5 cm in each case, and stored in a waterbath at 90° C. for in each case h, 1 h, 4 h and 24 h. In addition, one test specimen in each case was processed further directly after cooling at room temperature, without water storage; these samples were designated “0 h” and show the state of the product directly after processing in the extruder.

After water storage and mechanical drying (except for “0 h” samples: after cooling—i.e. no water storage, no drying), with the aid of a lathe, turnings with a thickness of 0.7 mm were shaved off from the test specimens. The turnings were extracted to DIN EN 579 in boiling xylene for 8 h. The gel content was determined by difference weighing of the sample before and after extraction and drying. The results are compiled in Table 3 below.

TABLE 3
Gel content (in %) before (0 h) and after water storage
(0.5 h, 1 h, 4 h, 24 h) and extraction to DIN EN 579

| | Test | | | | | |
|---|---|---|---|---|---|---|
| Ex. | specimen | Gel content after | | | | |
| No. | from Ex. No. | 0 h | ½ h | 1 h | 4 h | 24 h |
| 5a | 4a | 19% | 22% | 38% | 54% | 72% |
| 5b** | 4b** | 41% | 53% | 60% | 68% | 74% |

**noninventive

For Example 5a, the period of 0½ hour reflects phase of the crosslinking kinetics (stabilization phase, attenuated crosslinking, water scavenger (W) reacts with penetrating water); the period of ½-24 hours reflects phase 2 of the crosslinking (fast cross-linking, polymer (P) crosslinked).

### Example 6

### Batchwise Silane Grafting onto Polymer, Preparation of a Polymer (P)

A highly branched polyethylene (Epolene® C-10 from Westlake Chemical (Houston, Tex., USA); 1100 g) was melted at 180° C. At this temperature, a mixture of 96.3 g (649.3 mmol) of silane A and 1.65 g (5.68 mmol) of 2,5-dimethyl-2,5-di(tert-butylperoxy)hexane was metered into the stirred melt within 30 minutes. After the end of the metering time, the mixture was stirred at 180° C. for a further 20 minutes, then volatile constituents were removed at 180° C. under reduced pressure, and the product was cooled to room temperature. This gave a colorless solid. Monitoring by ICP (inductively coupled plasma, element to be analyzed: Si) showed a silicon content in the graft product of 1.15%, which corresponds to a content of grafted vinyltrimethoxysilane (silane A-grafted) of 6.06% (409 mmol/kg).

The graft polymer contained the following structural units: Pol[-CH₂—CH₂—Si(OMe)₃]_{b} and Pol[-CH(Me)-Si(OMe)₃]_{b} corresponding to the definition of a polymer (P), the unit Pol- in these structural units representing a radical of the highly branched polyethylene used, and where b was principally in the range of 1-6, especially around 3.

### Example 7

### Production of Inventive Mixtures (M) and of Test Specimens for the Crosslinking

The product from Example 6 was melted, divided into three parts and blended with silane B or silane C and/or catalyst A according to the mixing ratios specified in Table 4.

TABLE 4
Composition of the test specimens for
the crosslinking (parts by weight)

| Example No. | 7a** | 7b | 7c** |
|---|---|---|---|
| Graft | 100* | 100* | 100* |
| polymer from | | | |
| Example 6 | | | |
| Silane B | | 2.784*** | |
| Silane C | | | 3.467*** |
| Catalyst A | 0.05 | 0.05 | 0.05 |

*Contains 409 mmol/kg of silane groups [—Si(OMe)₃].
**Comparative example (noninventive).
***Water scavenger loading: 100 mmol per kg of graft product from Example 6.

Example 7a is not an inventive mixture (M) since it does not contain any water scavenger. The mixture according to Example 7c is noninventive since the selection of the combination of polymer-bound hydrolyzable silane groups in polymer (P) and of silane groups of the water scavenger does not satisfy any of the options (A), (B), (C) or (D) for the inventive possible combinations of structural elements of the formulae I and II.

### Example 8a-c

### Crosslinking Characteristics

The mixtures from Example 7a-c were cooled to room temperature under protective gas (argon), such that they solidified. A drill was used to remove turnings, and these were stored at 90° C. in a waterbath for h, 1 h, 4 h and 24 h. In addition, one test specimen in each case was processed further directly after cooling to room temperature, without water storage; these samples were designated “0 h” and show the state of the product directly after the production of the mixture (M).

After water storage and mechanical drying (except for “0 h” samples: after cooling—i.e. no water storage, no drying), the turnings were extracted in boiling xylene for 4 h, based on DIN EN 579. The gel content was determined by difference weighing of the sample before and after extraction and drying. The results are compiled in Table 5 below.

TABLE 5
Gel content (in %) before (0 h) and after water storage
(0.5 h, 0.75 h, 1 h, 2 h, 4 h, 6.5 h, 24 h, 48 h,
72 h) and extraction based on DIN EN 579.

Ex. No.

| | | |
|---|---|---|
| 8a** | 8b | 8c** |

Test specimen from Ex. No.

| | | |
|---|---|---|
| 7a** | 7b | 7c** |

Gel content after

| | | | | |
|---|---|---|---|---|
| 0 | h | 0.75% | 0.00% | 0.28% |
| 0.5 | h | 7.11% | 0.05% | 13.06% |
| 0.75 | h | 21.25% | 8.77% | 36.41% |
| 1 | h | 31.22% | 22.35% | 47.86% |
| 2 | h | 55.69% | 55.43% | 62.64% |
| 4 | h | 66.64% | 69.36% | 71.70% |
| 6.5 | h | 67.34% | 70.78% | 72.25% |
| 24 | h | 70.93% | 73.69% | 74.31% |
| 48 | h | 73.51% | 75.26% | 75.50% |
| 72 | h | 74.44% | 75.73% | 76.58% |

**noninventive

For Example 8b, the period of 0-0.5 hour reflects phase 1 of the crosslinking kinetics (stabilization phase, attenuated crosslinking, water scavenger (W) reacts with penetrating water); the period of 0.5-4 hours reflects phase 2 of the crosslinking (fast cross-linking, polymer (P) crosslinked). The example shows that the inventive mixture (M) according to Example 7b exhibits the desired 2-phase crosslinking kinetics (i.e. no measurable crosslinking in phase 1 compared to the same system without water scavenger (=noninventive mixture from Example 7a), but unattenuated fast crosslinking in phase 2). Accordingly, a water scavenger with different levels of reactivity of water scavenger vs. reactivity of polymer (P) toward water (see Example 7c; noninventive, since none of conditions (A), (B), (C) or (D) is met) acts more as a crosslinker than as a water scavenger.

1. A stabilized mixture (M) comprising polymer (P) moisture-crosslinkable to give a crosslinked polymer (PV), said polymer (P) containing hydrolyzable silane groups at least one site which is not at either end of at polymer backbone, and silane (W) reacting with at least one hydrolyzable group as a water scavenger which reacts faster with water at 25° C. and 1 bar than the moisture-crosslinkable polymer (P),
wherein the polymer (P) has at least one structural element of the general formula I
Pol[-(R²)ₚ—SiR¹₃₋ₐXₐ]_{b} (I)
at least one site on the polymer which is not at either end of the polymer backbone, where
Pol- is a polymeric radical with a number-average molar mass Mₙ of at least 500 g/mol,
R¹ is an unsubstituted or mono- or poly-Q-substituted C₁-C₁₈ alkyl or C₆-C₁₀ aryl or Si₁-Si₂₀ siloxy radical or fused silane hydrolysate of silanes having 1, 2, 3 or 4 hydrolyzable groups,
R² is a divalent unsubstituted or mono- or poly-Q-substituted hydrocarbyl radical having 1-20 carbon atoms, which may be interrupted by one to three heteroatoms, or a siloxane radical having 1-20 silicon atoms, in which the silicon atoms may likewise bear R¹ or X groups,
Q is a fluorine, chlorine, bromine, iodine, cyanato, isocyanato, cyano, nitro, nitrato, nitrito, silyl, silylalkyl, silylaryl, siloxy, siloxanoxy, siloxyalkyl, siloxanoxyalkyl, siloxyaryl, siloxanoxyaryl, oxo, hydroxyl, epoxy, alkoxy, aryloxy, acyloxy, S-sulfonato, O-sulfonato, sulfato, S-sulfinato, O-sulfinato, amino, alkylamino, arylamino, dialkylamino, diarylamino, arylalkylamino, acylamino, imido, sulfonamido, imino, mercapto, alkylthio or arylthio substituent, O-alkyl-N-carbamato, O-aryl-N-carbamato, N-alkyl-O-carbamato, N-aryl-O-carbamato, optionally alkyl- or aryl-substituted P-phosphonato, optionally alkyl- or aryl-substituted O-phosphonato, optionally alkyl- or aryl-substituted P-phosphinato, optionally alkyl- or aryl-substituted O-phosphinato, optionally alkyl- or aryl-substituted phosphino, hydroxycarbonyl, alkoxy-carbonyl, aryloxycarbonyl, cyclic or acyclic carbonate, alkylcarbonato or arylcarbonato substituent,
p is 0 or 1,
a is 1, 2 or 3,
b is an integer value greater than or equal to 1, and
x is a hydrolyzable group,
and where two or more radicals or groups within the formula I may be joined to one another so as to form one or more rings,
wherein the water scavenger is silane (W) of the general formula II
(R³)_{4-c-q}(Y)_{c}Si(CH₂—Z)_{q} (II)
where
R³ has the same definitions as R¹ or as X,
q is 0, 1, 2 or 3,
c is 1, 2, 3 or 4,
Y is a hydrolyzable group,
Z is a heteroatom-containing group bonded to the CH₂ group via a heteroatom,
q+c is 1, 2, 3 or 4,
and where two or more radicals or groups within the general formula II may be joined to one another so as to form one or more rings,
with the proviso that
(A) X and Y are selected such that a selected pKₐ of a Brønsted acid YH conjugated to give Y⁻ is lower than a pKₐ of a Brønsted acid XH conjugated to give X⁻, where Y⁻ is a leaving group on a silicon atom of structural elements of the general formula II and X⁻ is a leaving group on the silicon atom of structural elements of the general formula I; when X or Y is an Si-bonded amino function, the pKₐ of a next-but-one conjugated acid to give X⁻ or Y⁻, such that the pKₐ of XH₂⁺ or of YH₂⁺ may be employed to compare the pKₐ values, such that the pKₐ of XH is, when neither X nor Y is an amino radical, compared with the pKₐ of YH; the pKₐ of XH is, when Y is an amino radical and X is not an amino radical, compared with the pKₐ of YH₂⁺; the pKₐ of XH₂^{±} is, when Y is not an amino radical and X is an amino radical, compared with the pKₐ of YH; and the pKₐ of XH₂⁺ is, when Y is an amino radical and X is an amino radical, compared with the pKₐ of YH₂⁺, or
(B) q in the general formula II is 1, 2 or 3, or
(C) X and Y are selected such that XH and YH are alcohols, XH being a hindered alcohol with greater steric demands in an environment of the alcoholic hydroxyl group than YH, a steric demand of a substituent on the alcoholic hydroxyl function being in ascending order in the series of methyl<ethyl<n-propyl<n-butyl<C₅-C₂₀ n-alkyl<isobutyl<isopropyl<sec-butyl<C₅-C₂₀ sec-alkyl<tert-butyl<tert-pentyl C₆-C₂₀ tert-alkyl, or
(D) a value selected for c in the general formula II is greater than a value of a in the general formula I.

2. A stabilized mixture (M) comprising polymer (P) moisture-crosslinkable to give a crosslinked polymer (PV), said polymer (P) containing hydrolyzable silane groups at least one site which is not at either end of the polymer backbone, and silane (W) reacting with at least one hydrolyzable group as a water scavenger which reacts faster with water at 90° C. and 1 bar than the moisture-crosslinkable polymer (P),
wherein the polymer (P) has at least one structural element of the general formula I
Pol[-(R²)ₚ—SiR¹₃₋ₐXₐ]_{b} (I)
at least one site on the polymer which is not at either end of the polymer backbone, where
Pol- is a polymeric radical with a number-average molar mass Mₙ of at least 500 g/mol,
R¹ is an unsubstituted or mono- or poly-Q-substituted C₁-C₁₈ alkyl or C₆-C₁₀ aryl or Si₁-Si₂₀ siloxy radical or fused silane hydrolysate of silanes having 1, 2, 3 or 4 hydrolyzable groups,
R² is a divalent unsubstituted or mono- or poly-Q-substituted hydrocarbyl radical having 1-20 carbon atoms, which may be interrupted by one to three heteroatoms, or a siloxane radical having 1-20 silicon atoms, in which the silicon atoms may likewise bear R¹ or X groups,
Q is a fluorine, chlorine, bromine, iodine, cyanato, isocyanato, cyano, nitro, nitrato, nitrito, silyl, silylalkyl, silylaryl, siloxy, siloxanoxy, siloxyalkyl, siloxanoxyalkyl, siloxyaryl, siloxanoxyaryl, oxo, hydroxyl, epoxy, alkoxy, aryloxy, acyloxy, S-sulfonato, O-sulfonato, sulfato, S-sulfinato, O-sulfinato, amino, alkylamino, arylamino, dialkylamino, diarylamino, arylalkylamino, acylamino, imido, sulfonamido, imino, mercapto, alkylthio or arylthio substituent, O-alkyl-N-carbamato, O-aryl-N-carbamato, N-alkyl-O-carbamato, N-aryl-O-carbamato, optionally alkyl- or aryl-substituted P-phosphonato, optionally alkyl- or aryl-substituted O-phosphonato, optionally alkyl- or aryl-substituted P-phosphinato, optionally alkyl- or aryl-substituted O-phosphinato, optionally alkyl- or aryl-substituted phosphino, hydroxycarbonyl, alkoxy-carbonyl, aryloxycarbonyl, cyclic or acyclic carbonate, alkylcarbonato or arylcarbonato substituent,
p is 0 or 1,
a is 1, 2 or 3,
b is an integer value greater than or equal to 1, and
x is a hydrolyzable group,
and where two or more radicals or groups within the formula I may be joined to one another so as to form one or more rings,
wherein the water scavenger is silane (W) of the general formula II
(R³)_{4-c-q}(Y)_{c}Si(CH₂—Z) (II)
where
R³ has the same definitions as R¹ or as X,
q is 0, 1, 2 or 3,
c is 1, 2, 3 or 4,
Y is a hydrolyzable group,
Z is a heteroatom-containing group bonded to the CH₂ group via a heteroatom,
q+c is 1, 2, 3 or 4,
and where two or more radicals or groups within the general formula II may be joined to one another so as to form one or more rings,
with the proviso that
(A) X and Y are selected such that a selected pKₐ of a Brønsted acid YH conjugated to give Y⁻ is lower than a pKₐ of a Brønsted acid XH conjugated to give X⁻, where Y⁻ is a leaving group on a silicon atom of structural elements of the general formula II and X⁻ is a leaving group on the silicon atom of structural elements of the general formula I; when X or Y is an Si-bonded amino function, the pKₐ of a next-but-one conjugated acid to give X⁻ or Y⁻, such that the pKₐ of XH₂⁺ or of YH₂⁺ may be employed to compare the pKₐ values, such that the pKₐ of XH is, when neither X nor Y is an amino radical, compared with the pKₐ of YH; the pKₐ of XH is, when Y is an amino radical and X is not an amino radical, compared with the pKₐ of YH₂⁺; the pKₐ of XH₂^{±} is, when Y is not an amino radical and X is an amino radical, compared with the pKₐ of YH; and the pKₐ of XH₂⁺ is, when Y is an amino radical and X is an amino radical, compared with the pKₐ of YH₂⁺, or
(B) q in the general formula II is 1, 2 or 3, or
(C) X and Y are selected such that XH and YH are alcohols, XH being a hindered alcohol with greater steric demands in an environment of the alcoholic hydroxyl group than YH, a steric demand of a substituent on the alcoholic hydroxyl function being in ascending order in the series of methyl<ethyl<n-propyl<n-butyl<C₅-C₂₀ n-alkyl<isobutyl<isopropyl<sec-butyl<C₅-C₂₀ sec-alkyl<tert-butyl<tert-pentyl C₆-C₂₀ tert-alkyl, or
(D) a value selected for c in the general formula II is greater than a value of a in the general formula I.

3. (canceled)

4. The stabilized mixture (M) as claimed in claim 1, in which the polymer (P), based on a total mass of (P), contains at least 0.01% of silane groups —[(R²)ₚ—SiR¹₃₋ₐXₐ]_{b}, based on a mass of all groups in relation to the total mass of polymer (P).

5-6. (canceled)

7. The stabilized mixture (M) as claimed in claim 1, which comprises at least one catalyst selected from the group consisting of organotin compounds, titanium compounds, aza compounds, bases, inorganic acids and organic acids.

8. A process for crosslinking polymers (P) in a mixture (M) according to claim 1 with water.

9. A silane of the general formula III
R⁴—CH₂—C(═O)—O—CH₂—Si(R⁵)_{3-c}(Y¹)_{c} (III)
where
R⁴ is a saturated or mono- or polyunsaturated, unsubstituted, acyclic, monocyclic or bicyclic C₃-C₄₀ alkyl radical or C₇-C₄₀ aryl radical or C₇-C₄₀ arylalkyl radical or C₇-C₄₀ alkylaryl radical which consists only of carbon and hydrogen atoms and
Y¹ is an optionally substituted C₁-C₂₀ alkoxy radical and
R⁵ is an unsubstituted C₁-C₄₀ hydrocarbyl radical and
c is 1, 2, 3 or 4.

10. The stabilized mixture (M) as claimed in claim 2, in which the polymer (P), based on a total mass of (P), contains at least 0.01% of silane groups —[(R²)ₚ—SiR¹₃₋ₐXₐ]_{b}, based on a mass of all groups in relation to the total mass of polymer (P).

11. The stabilized mixture (M) as claimed in claim 2, which comprises at least one catalyst selected from the group consisting of organotin compounds, titanium compounds, aza compounds, bases, inorganic acids and organic acids.

12. A process for crosslinking polymers (P) in a mixture (M) according to claim 2 with water.
